(19) United States
(12) Patent Application Publication
(10) Pub. No.: US 2013/0198635 A1
(43) Pub. Date: Aug. 1, 2013

(54) Managing Multiple Participants at the Same Location in an Online Conference

(71) Applicant: American Teleconferencing Services, Ltd., Atlanta, GA (US)

(72) Inventors: Boland T. Jones, Atlanta, GA (US); David Michael Guthrie, Norcross, GA (US); Mark A. Sjurseth, Smyrna, GA (US); John P. Keane, Marietta, GA (US)

(73) Assignee: American Teleconferencing Services, Ltd., Atlanta, GA (US)

(21) Appl. No.: 13/801,683

(22) Filed: Mar. 13, 2013

Related U.S. Application Data
(63) Continuation-in-part of application No. 12/772,069, filed on Apr. 30, 2010.
Application No. 12/772,069 is a continuation-in-part of application No. 12/771,522, filed on Apr. 30, 2010.

(51) Int. Cl. G06F 3/16

(52) U.S. Cl. CPC G06F 3/167
USPC 715/727

(57) ABSTRACT

Various embodiments of systems, methods, and computer programs are disclosed for managing multiple participants at the same location in an online conference. One embodiment is a method for providing an online conference comprising: a conferencing system establishing an audio conference with a plurality of client devices via a communication network, each client device associated with a first participant; the conferencing system determining at least one second participant co-located with one of the first participants and the corresponding client device; and the conferencing system presenting, to each of the client devices, the audio conference and a conference user interface, the conference user interface displaying a participant object identifying each of the first and second participants.

### CROSS-REFERENCE TO RELATED APPLICATIONS

This application is a continuation-in-part patent application of and claims the benefit of the priority of the following patent applications, each of which is hereby incorporated by reference in its entirety: U.S. patent application Ser. No. 12/772,069, entitled “Managing Conference Sessions via a Conference User Interface” and filed Apr. 30, 2010 (Attorney Docket No. 16003.1210U1); and U.S. patent application Ser. No. 12/771,522, entitled “Transferring a Conference Session Between Client Devices” and filed Apr. 30, 2010 (Attorney Docket No. 16003.1219U1).

### BACKGROUND

Currently, there are a number of conference solutions for enabling people to conduct live meetings, conferences, presentations, or other types of gatherings via the Internet, the public switched telephone network (PSTN), or other voice and/or data networks. Participants typically use a telephone, computer, or other communication device that connects to a conference system. The meetings include an audio component and a visual component, such as, a shared presentation, video, whiteboard, or other multimedia, text, graphics, etc. These types of convenient conference solutions have become an indispensable form of communication for many businesses and individuals.

Despite the many advantages and commercial success of existing conference, meeting, grouping or other types of gathering systems, there remains a need in the art for improved conference, meeting, grouping or other types of gathering systems, methods, and computer programs.

### SUMMARY

Various embodiments of systems, methods, and computer programs are disclosed for managing multiple participants at the same location in an online conference. One embodiment is a method for providing an online conference comprising: a conferencing system establishing an audio conference with a plurality of client devices via a communication network, each client device associated with a first participant; the conferencing system determining at least one second participant co-located with one of the first participants and the corresponding client device; and the conferencing system presenting, to each of the client devices, the audio conference and a conference user interface, the conference user interface displaying a participant object identifying each of the first and second participants.

Another embodiment is a computer program embodied in a computer readable medium and executable by a processor for providing an online conference. The computer program comprises: logic configured to establish an audio conference with a plurality of client devices via a communication network, each client device associated with a first participant; logic configured to present, to each of the client devices, the audio conference and a conference user interface, the conference user interface displaying a participant object identifying each of the first participants; logic configured to determine, during the audio conference, an identity of a second participant co-located with one of the first participants and the corresponding client device; and logic configured to add a further participant object to the conference user interface to identify the second participant.

Yet another embodiment is a computer system comprising a conferencing system and a server. The conferencing system establishes an audio conference with a plurality of client devices via a communication network. Each client device is associated with a first participant in the audio conference. The server is configured to communicate with the conferencing system and the plurality of client devices via the communication network. The server is further configured to: present, to each of the client devices, the audio conference and a conference user interface, the conference user interface displaying a participant object identifying each of the first participants; determine an identity of a second participant co-located with one of the first participants and the corresponding client device; and in response to determining the identity of the second participant, update the conference user interface with a further participant object identifying the second participant.

### BRIEF DESCRIPTION OF THE DRAWINGS

FIG. 1 is a block diagram illustrating an embodiment of a computer system for managing multiple participants at the same location in an online conference.

FIG. 2 is a flowchart illustrating an embodiment of a method for managing multiple participants at the same location in an online conference.

FIG. 3 is a user interface screen shot illustrating an embodiment of the conference user interface of FIG. 1 for displaying co-located participants in the online conference.

FIG. 4 is a block diagram illustrating another embodiment of a computer system for managing multiple participants at the same location in an online conference.

FIG. 5 is a flowchart illustrating an embodiment of a method for determining the identity of the additional co-located participants.

FIG. 6 is a user interface screen shot illustrating an embodiment of a conference user interface for enabling a participant to add co-located participants.

FIG. 7 illustrates the conference user interface of FIG. 6 after the co-located participants have been added to the online conference.

FIG. 8 illustrates the conference user interface of FIG. 7 in which one of the co-located participants is identified as a speaker.

FIG. 9 is a block diagram illustrating an embodiment of the computer system of FIGS. 1 & 4 in which a co-located participant establishes a connection to the online conference via a second client device.

FIG. 10 is a flowchart illustrating an embodiment of a method for enabling a co-located participant to establish a connection to the online conference via a second client device.

FIG. 11 is a user interface screen shot of a conferencing application on the second client device displaying a message from the conferencing system.

FIG. 12 is a user interface screen shot of an email message displayed on the second client device for initiating a request to establish the connection to the online conference.

FIG. 13 is a user interface screen shot of an embodiment of the conference user interface displayed on the second client device.

### DETAILED DESCRIPTION

Various embodiments of systems, methods, and computer programs are disclosed for managing multiple participants at the same location in an online conference. The online conference may provide a visually engaging conference experience to participants of a conference via a conference user interface presented to a client device. The online conference may be used for conferences, meetings, groupings or other types gatherings (collectively, a “conference” with a system that provides the public and private conference user interfaces for the conference being referred to herein as a “conferencing system”) for any variety of purposes of one or more people, groups or organizations (including combinations thereof and collectively referred to as “participants”) with or without an audio component, including, without limitation, enabling simulcast audio with such conference for the participants. The conference user interface may be configured to provide any desirable content and/or functionality and may support various user interface and/or conferencing features, including any features described in the above-referenced related patent applications.

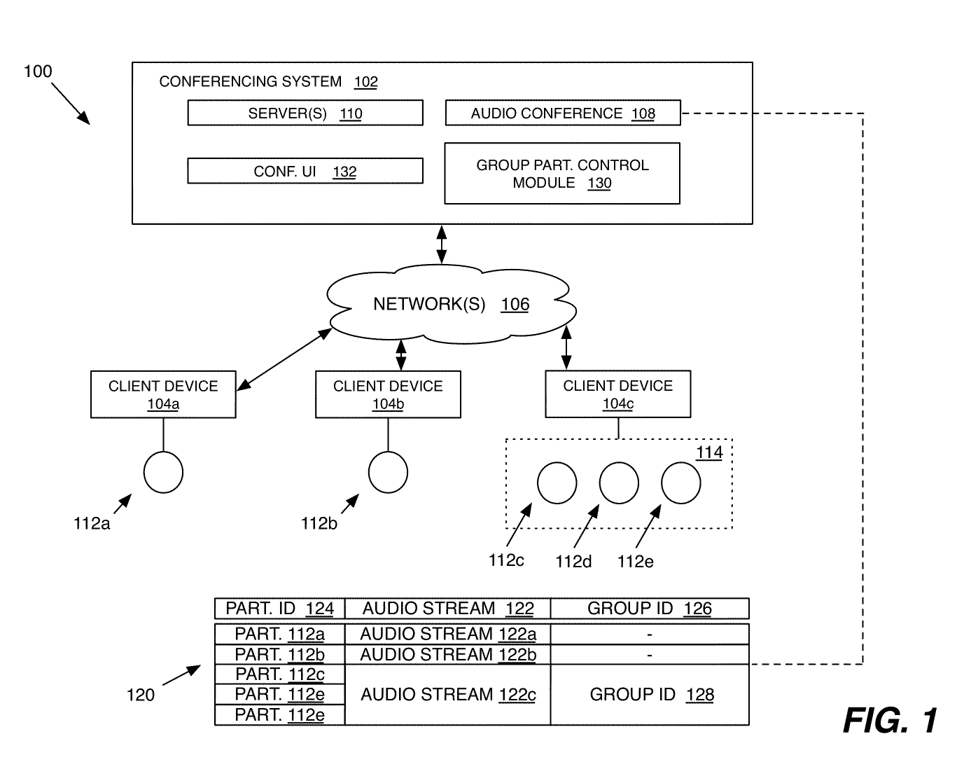

FIG. 1 illustrates an embodiment of a computer system 100 for managing multiple participants at the same location in an online conference. The computer system 100 comprises a conferencing system 102 and a plurality of client devices 104 connected via one or more communication networks 106. Each client device 104 is associated with at least one participant 112 in the online conference. Client devices 104a and 104b may be associated with a single participant (i.e., participants 112a and 112b, respectively), and client device 104c may be associated with a plurality of participants (i.e., participants 112c, 112d, and 112e). Participants 112c, 112d, and 112e are referred to as co-located participants or a group participant 114 because they experience the online conference with the same client device 104c at the same location. As described below in more detail, the conferencing system 102 comprises a group participant control module 130 for configuring, controlling, and managing the group participant 114, as well as control certain aspects of the conference user interface 132 displayed to the client devices 104.

The network(s) 106 may support wired and/or wireless communication via any suitable protocols, including, for example, the Internet, the Public Switched Telephone Network (PSTN), cellular or mobile network(s), local area network(s), wide area network(s), or any other suitable communication infrastructure. The client devices 104 may be associated with corresponding participants of the online conference, such as, an audio conference 108. Participants 112 may comprise a “host” or “participant” and such terms merely refer to different user roles or permissions associated with the audio conference 108. For example, the “host” may be the originator of the audio conference 108 and, consequently, may have user privileges that are not offered to the participants. Nonetheless, it should be appreciated that the terms “host,” “participant,” and “user” may be used interchangeably depending on the context in which it is being used.

The client devices 104 may comprise any desirable computing device, which is configured to communicate with the conferencing system 102 and the server(s) 110 via the networks 106. The client device 104 may comprise, for example, a personal computer, a desktop computer, a laptop computer, a mobile computing device, a portable computing device, a smart phone, a cellular telephone, a landline telephone, a soft phone, a web-enabled electronic book reader, a tablet computer, or any other computing device capable of communicating with the conferencing system 102 and/or the server(s) 110 via one or more networks 106. The client device 104 may include client software (e.g., a browser, plug-in, or other functionality) configured to facilitate communication with the conferencing system 102 and the server 110. It should be appreciated that the hardware, software, and any other performance specifications of the client device 104 are not critical and may be configured according to the particular context in which the client device 104 is to be used.

In the embodiment of FIG. 1, the conferencing system 102 generally comprises a communication system for establishing an online conference (e.g., an audio conference 108) between the client devices 104. The conferencing system 102 may support audio via a voice network and/or a data network. In one of a number of possible embodiments, the conferencing system 102 may be configured to support, among other platforms, a Voice Over Internet Protocol (VoIP) conferencing platform such as described in U.S. patent application Ser. No. 11/637,291 entitled “VoIP Conferencing,” filed on Dec. 12, 2006, which is hereby incorporated by reference in its entirety. It should be appreciated that the conferencing system 102 may support various alternative platforms, technologies, protocols, standards, features, etc. Regardless of the communication infrastructure, the conferencing system 102 may be configured to establish an audio connection with the client devices 104, although in some embodiments the audio portion may be removed.

The conferencing system 102 may establish the audio conference 108 by combining audio streams 122a, 122b, and 122c associated with client devices 104a, 104b, and 104c, respectively. As illustrated in FIG. 1, the conferencing system 102 may maintain a database 120 stored in a memory for controlling the audio streams 122 with corresponding client devices 104 and participants 112. Database 120 may comprise a list of participant identifiers 124 identifying each of the participants 112. Each audio stream 122 is logically associated with the corresponding participants 112 located with the client device 104. In the example of FIG. 1, the audio stream 122c for the client device 104c is logically associated with the participant identifiers 124 for each of the co-located participants (participants 112c, 112d, and 112e). During the audio conference 108, the audio stream 122c sends and controls audio signals from each of the participants 112c, 112d, and 112e to the conferencing system 102. Database 120 may further comprise a group identifier 126 that controls whether the audio stream 122 is associated with a group participant 114. In FIG. 1, the group participant 114 may comprise a group identifier 128.

Conferencing system 102 may comprise one or more server(s) 110 that are configured to establish the audio conference 108. Server(s) 110 may be operatively connected to one or more of the group participant control module 130, the audio conference 108, and a conference user interface 132. Group participant control module 132 is configured to manage, configure, and control the database 120, as well as control certain aspects of the presentation of the conference user interface 132 to the client devices 104. The conference user interface 132 may be presented via a client application (e.g., a browser, one or more browser plug-ins, and/or a special-purpose client). It should be appreciated that the conference user interface 132 may include logic located and/or executed at the client device 104, the conferencing system 102, or any combination thereof, and may be presented to and displayed via a graphical user interface and an associated display (e.g., touchscreen display device or other display device).

The group participant control module 130 (and any other associated control and presentation modules) may be embodied in memory and executed by one or more processors. It should be appreciated that any aspects of the group participant control module 130 may be stored and/or executed by the client devices 104, the conferencing system 102, the servers 110, or other related server(s) or web services.

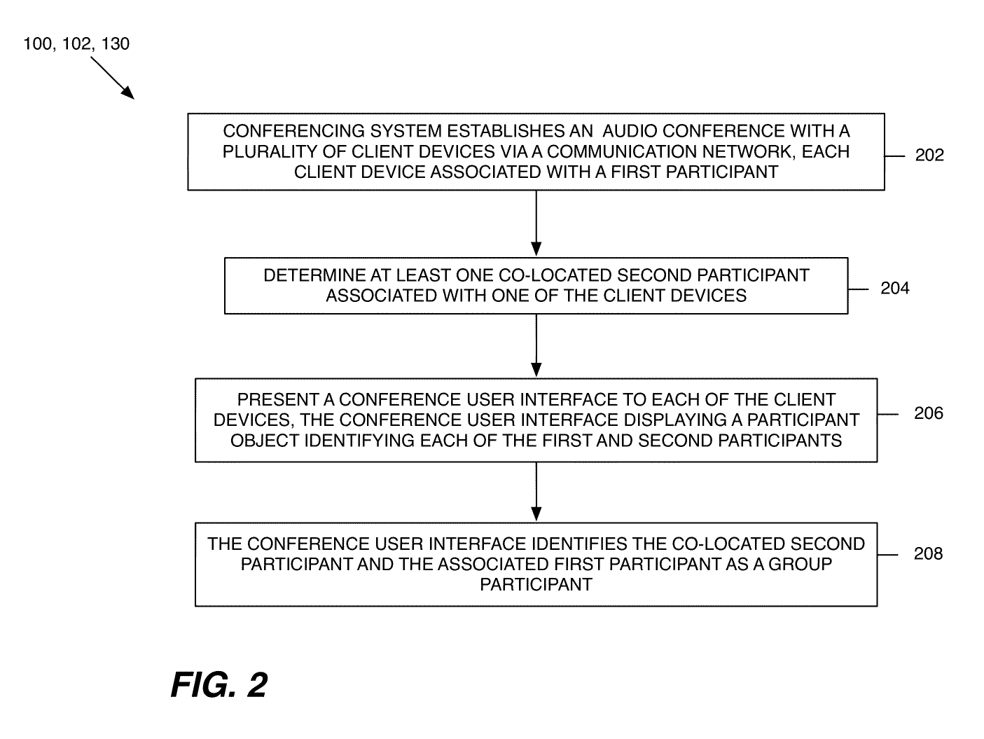

FIG. 2 is a flowchart illustrating the architecture, operation, and/or functionality of an embodiment of the computer system 100 of FIG. 1 for managing the co-located participants (participants 112c, 112d, and 112e) at the client device 104c. At block 202, the conferencing system 102 establishes the audio conference 108 with client devices 104a, 104b, and 104c via the communication network(s) 106. At block 204, the conferencing system 102 determines that the client device 104c has additional co-located participants. As described below in more detail, the conferencing system 102 may identify the co-located participants in various ways. For example, in an embodiment, the participant 112c may add the participants 112d and 112e via the conference user interface 132. In other embodiments, the conferencing system 102 may automatically identify multiple participants at a single location by monitoring and processing voice signals in the audio stream 122c. Client device 104c may also capture images of the location (e.g., via a camera or video camera), determine that there are multiple co-located participants, and prompt a first participant 112c to manully add the additional participants 112d and 112e. Client device 104c may also send the image data to the conferencing system 102 for comparison against stored user voice/image data, which enable the conferencing system 102 to determine the identify of the participants.

At block 206, the conferencing system 102 presents the conference user interface 132 to each of the client devices 104. The conference user interface 132 identifies each of the participants 112 in the audio conference, including the additional participants 112d and 112e. At block 208, the conferencing user interface 132 may also identify that the co-located participants 112c, 112d, and 112e are participating in the audio conference 108 as group participant 114.

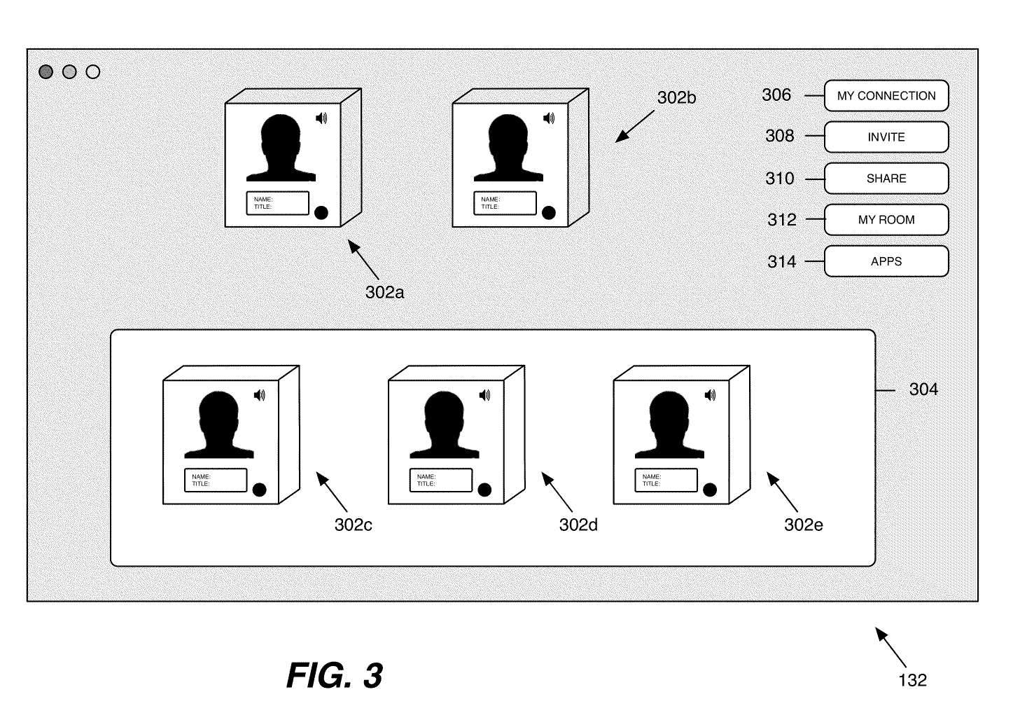

FIG. 3 illustrates an exemplary embodiment of the conference user interface 132 in which the participants 112a, 112b, 112c, 112d, and 112e are identified with interactive participant objects 302a, 302b, 302c, 302d, and 302e, respectively. Co-located participants 112c, 112d, and 112e may be identified as comprising group participant 114 via, for example, a boundary 304. The interactive participant object 302 may display similar information as described in the above-referenced international patent applications (e.g., a graphical representation, profile information, an audio indicator, a business card component, etc.) and may implement similar or other user interface or other functions and features. In an embodiment, a business card component may “flip” the participant object 302 to display additional parameters. The interactive participant objects 302 may comprise further interactive functionality and visual effects. For example, the participant object 302 may comprise a cube having multiple display faces. When a participant selects a user interface component, the cube may be expanded to display one or more faces of the object.

Participant objects 302 may be selected by the participants 112, as described in the above-referenced patent applications. The user selection may trigger the display of the cube faces. Each face may display additional information about the associated participant. In an embodiment, the cube faces may be configurable by the participant and may display, for example, a social networking profile, updates to a social networking communication channel, video, graphics, images, or any other content. The cube faces may be further selected to return to the original collapsed cube. In another embodiment, the participant objects 302 may be rotated (either automatically or via user selection) to display the respective cube faces. It should be appreciated that the participant objects 302 may be configured with additional or alternative visual effects and/or interactive functionality.

The conference user interface 132 may comprise one or more selectable components for accessing various conferencing features. A my connection component 306 may launch a display for enabling a participant to configure the existing connection between the client device 104 and the conferencing system 102. The participant may disconnect a connection to the audio conference 108, establish a new connection to the audio conference 108 (e.g., by dial-out), or reconfigure the existing connection to the audio conference 108. In addition to configuring the audio connection, the participant may also configure the connection to the online conference via the conference user interface 132.

An invite component 308 may launch a menu for enabling a participant to invite additional participants to the online conference or adding co-located participants. Additional participants may be invited by, for example, dialing out to a telephone number, sending an email including information for accessing the conferencing system 102, or sending a message to a web service, such as, for example, a social networking system.

A share component 310 may launch a menu (not shown) for enabling a participant to insert and share media with other participants in the online conference, as described in the above-referenced related patent applications.

A my room component 312 may launch a display for enabling a participant to configure the appearance of the conference user interface. The participant may configure the arrangement of the participant objects 302, specify a location view (as described in the above-reference international patent application), or configure any other presentation parameter.

An apps component 314 may launch a menu for enabling a participant to launch, view, or purchase various conference applications provided by the conferencing system 102.

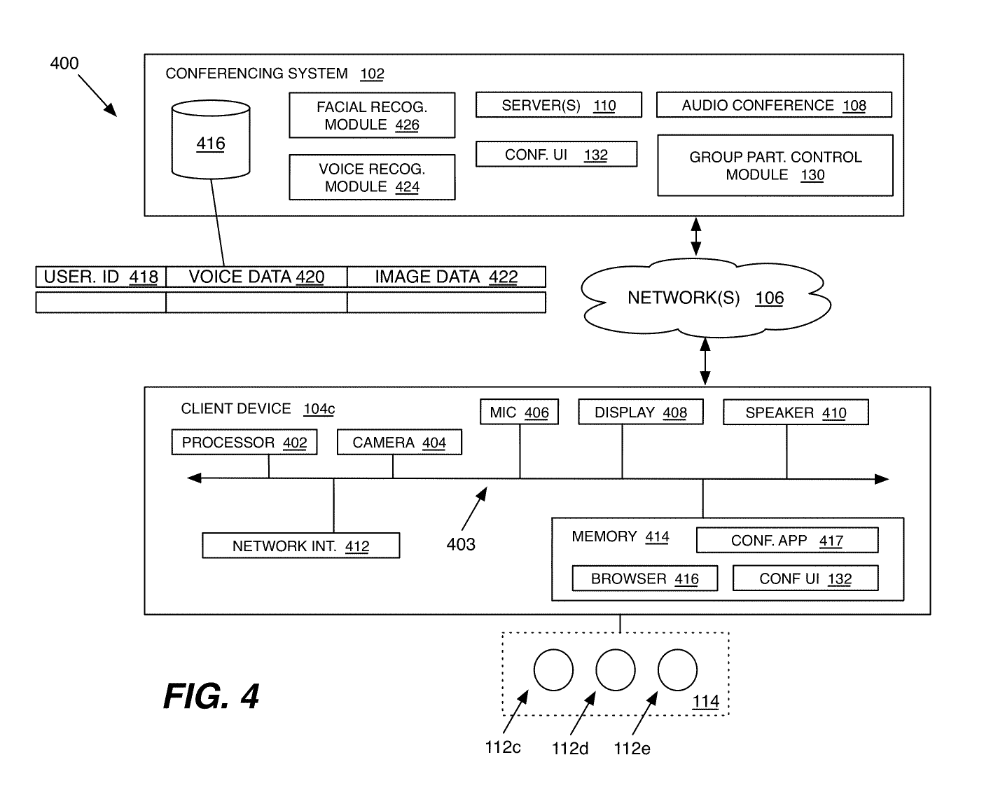

FIG. 4 illustrates another embodiment of a computer system 400 for managing group participant 114 and determining the identity of the additional co-located participants 112d and 112e. Client device 104c may comprise a processor 402, a camera 404 for capturing still images and/or video, a microphone 406 for receiving sounds to be sent to the conferencing system 102 via audio stream 122c, a display device 408 for presenting the conference user interface 132, a speaker 410 for playing the audio conference 108, network interface device(s) 412 for communicating via network(s) 106, and a memory 414, all of which may be interconnected via a local interface 403. Memory 414 comprises a browser 416 and a mobile conferencing application 417 (or other modules for managing, configuring, and controlling the group participant 114). Processor 402 controls the operation of the various devices on the client device 104c, including executing any software modules stored in the memory 414.

Conferencing system 102 may comprise a user profiles database 416, a voice recognition module 424, and a facial recognition module 426 executed by server(s) 110. User profiles database 416 may store user voice data 420 and user facial image data 422 for various users of the conferencing system 102 according to user identifiers 418. Voice recognition module 424 comprises logic configured to process the audio streams 122, compare the voice data on the audio streams 122 to user voice data 420, and identify a corresponding user identifier 418 for a participant 112. Facial recognition module 426 comprises logic configured to process images (still or motion) captured by the camera 404, compare the image data to user facial image data 422, and identify a corresponding user identifier 418 for a participant 112.

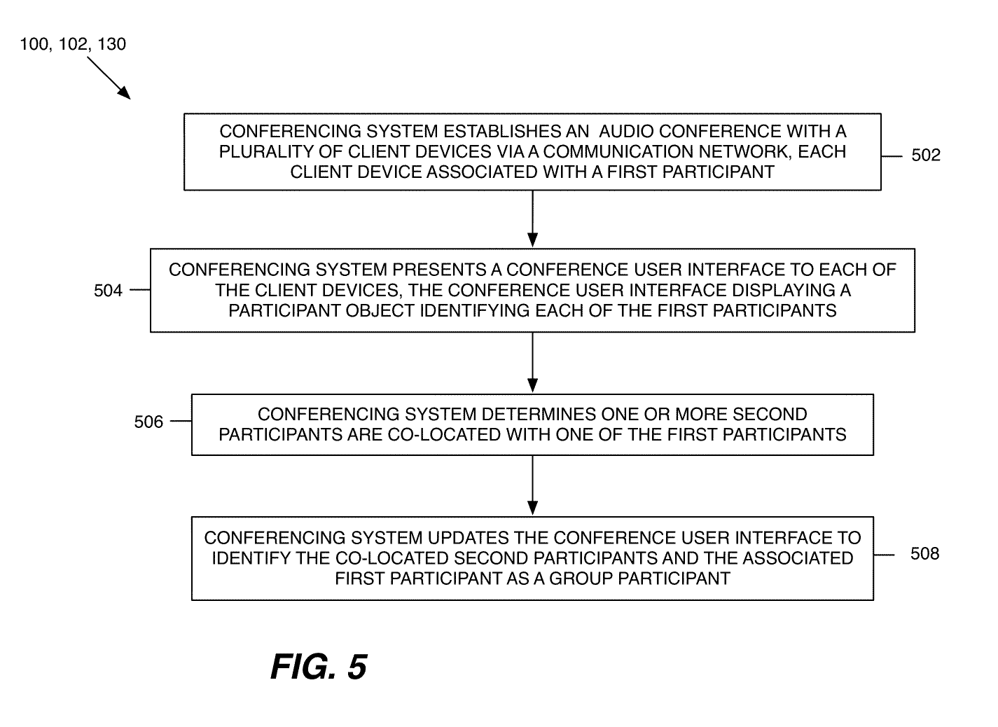

FIG. 5 illustrates an embodiment of a method implemented by the computer system 400 for determining the identity of the additional co-located participants 112d and 112e. At block 502, the conferencing system 102 establishes the audio conference 108 with the client devices 104a, 104b, and 104c. Initially, the audio conference 108 may only include the participants 112a, 112b, and 112c. At block 504, the conferencing system 102 presents the conference user interface 132 to the client devices 104, in the manner described above, by displaying a participant object 302 for each of the participants 112a, 112b, and 112c. During the audio conference 108, at block 506, the conferencing system 102 determines that one or more of the participants 112d and 112e are co-located with participant 112c.

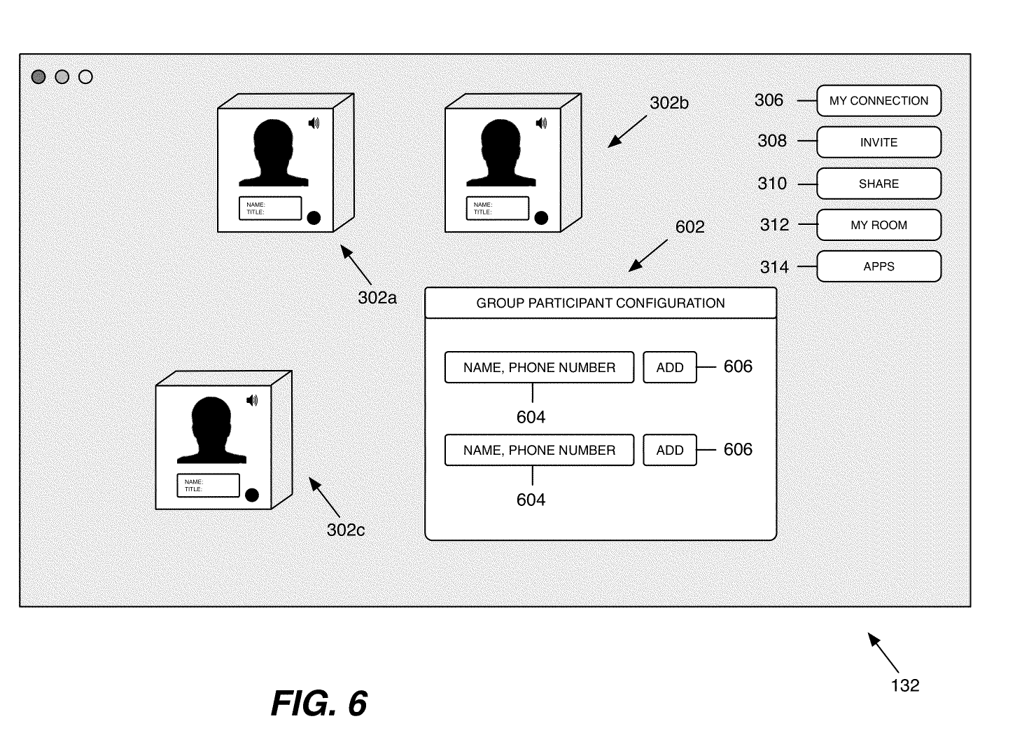

In one embodiment, the participant 112c may specify the participants 112d and 112e via the conference user interface 132. As illustrated in FIG. 6, the conference user interface 132 may initially display only participant objects 302a, 302b, and 302c. The conference user interface 132 may present a group participant menu 602 that prompts the participant 112c to specify the participants 112d and 112e to be added to the online conference and associated with the client device 104c as group participant 114. The participant 112c may specify the additional participants according to name, telephone number, or a username associated with conferencing system 102, a social networking service, or any other user parameters (component 604), and automatically add them to the online conference by selecting an add button 606. Group participant menu 602 may also enable the participant 112c to search a corporate directory or contacts list stored on the client device 104c or maintained by the conferencing system 102, select the participant, and add the participant via add button 606.

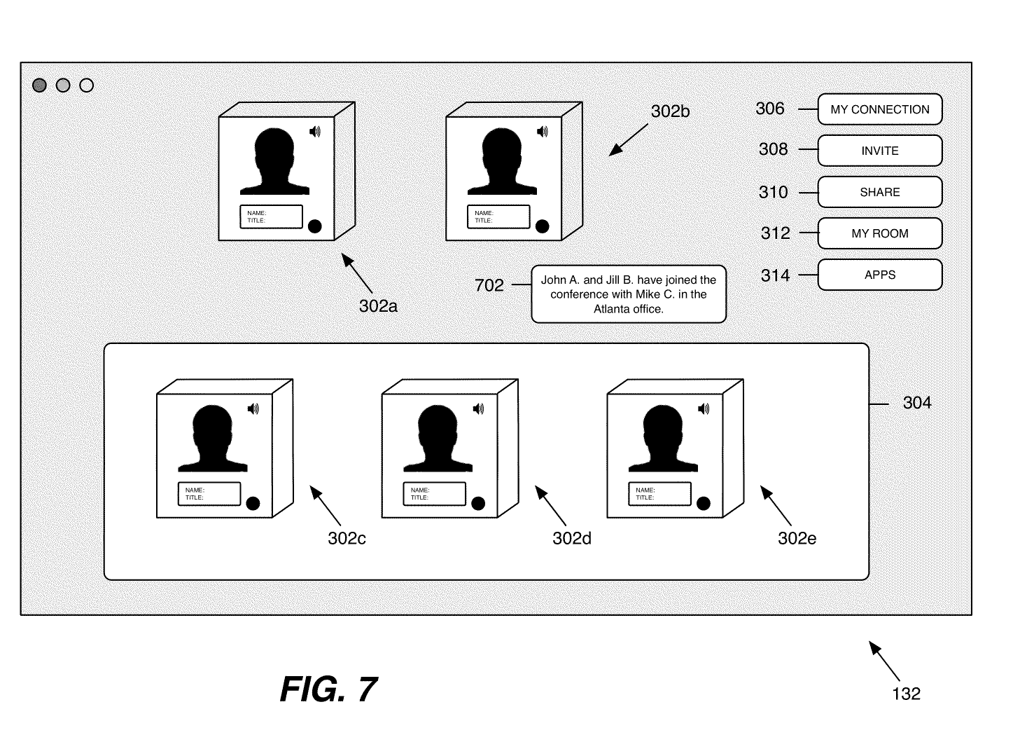

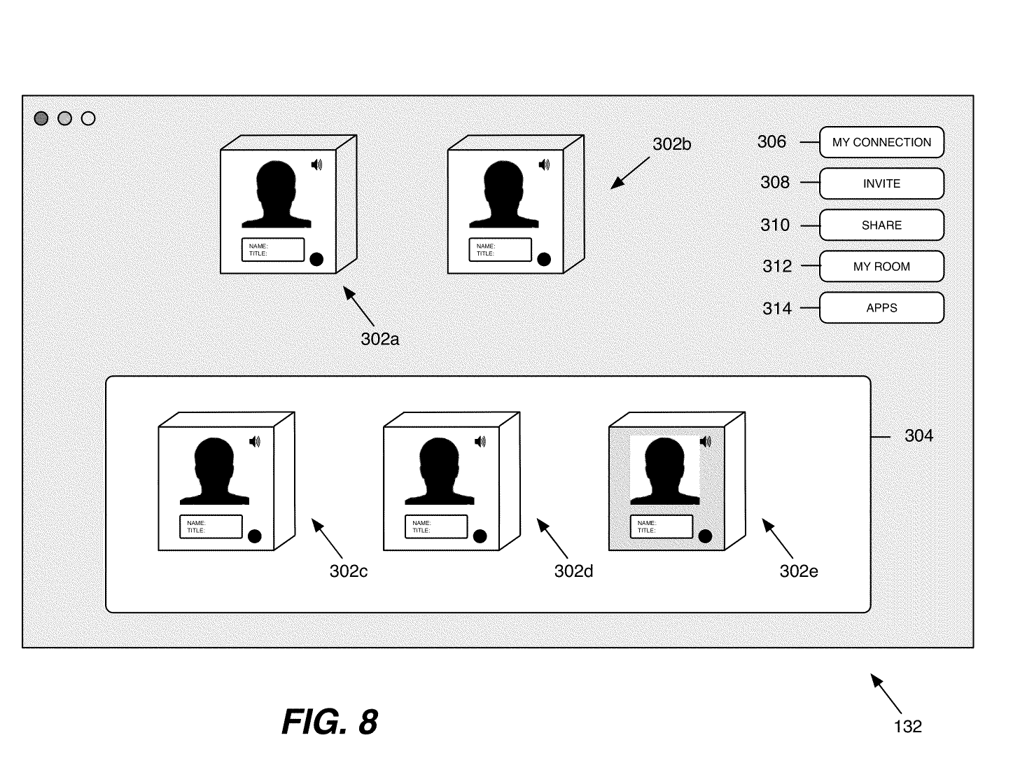

Referring again to FIG. 5, at block 506, the conferencing system 102 receives the identification information from the client device 104c. The conferencing system 102 may perform a look-up to user profiles database 416 to select an appropriate user identifier 418. At block 508, the conferencing system 102 may update the conference user interface 132 by adding corresponding participant objects 302d and 302e (FIG. 7) and providing an alert or notification message 702 indicating that participants 112d and 112e have entered the online conference at the same location as participant 112c. When the group participant 114 is activated, the group participant control module 130 and/or the voice recognition module 424 may monitor the audio stream 122c, compare the voice data to user voice data 420, and automatically identify which participant 112c, 112d, or 112e is currently speaking As illustrated in FIG. 8, the conferencing user interface 132 may visually identify the current speaker from the co-located participants by highlighting the corresponding participant object 302e.

As mentioned above, in alternative embodiments, the voice recognition module 424 may automatically identify the co-located participants 112d and 112e without input from the participant 112c by monitoring and processing voice signals in the audio stream 122c. Client device 104c may also capture images of the location via camera 404 and determine that there are multiple participants. Client device 104c may prompt participant 112c to specify their identities, as described above, or the images may be transmitted to the conferencing system 102 for automatic identification by facial recognition module 426.

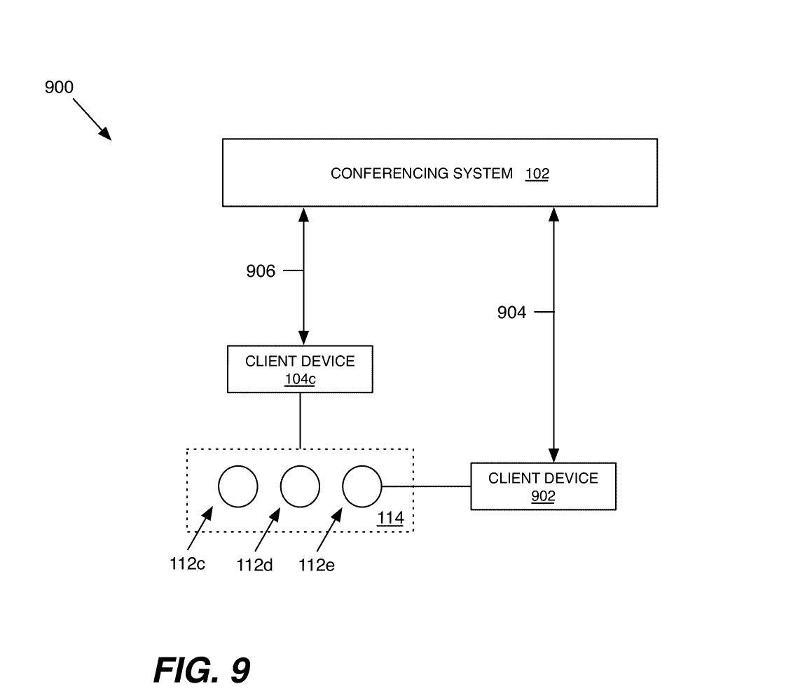

FIG. 9 illustrates another embodiment of a computer system 900 for enabling one of the co-located participants 112 from group participant 114 to establish a separate connection 904 with the online conference. While the existing connection 906 with client device 104c, the participant 112c may desire to connect a second client device 902 to the online conference. The separate connection 904 may be selectively configured without a supporting audio connection, if the participant desires, such that only the conference user interface 132 is presented to the second client device 902. In other embodiments, the separate connection 904 may include a separate audio stream 122 dedicated to the second client device.

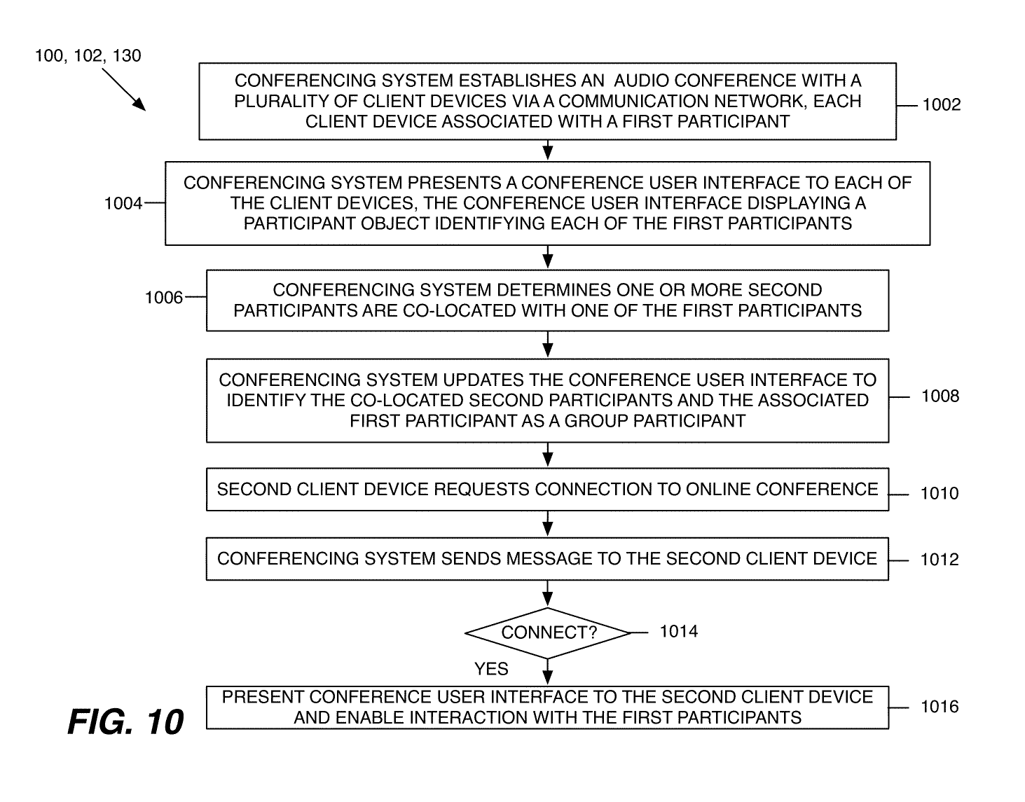

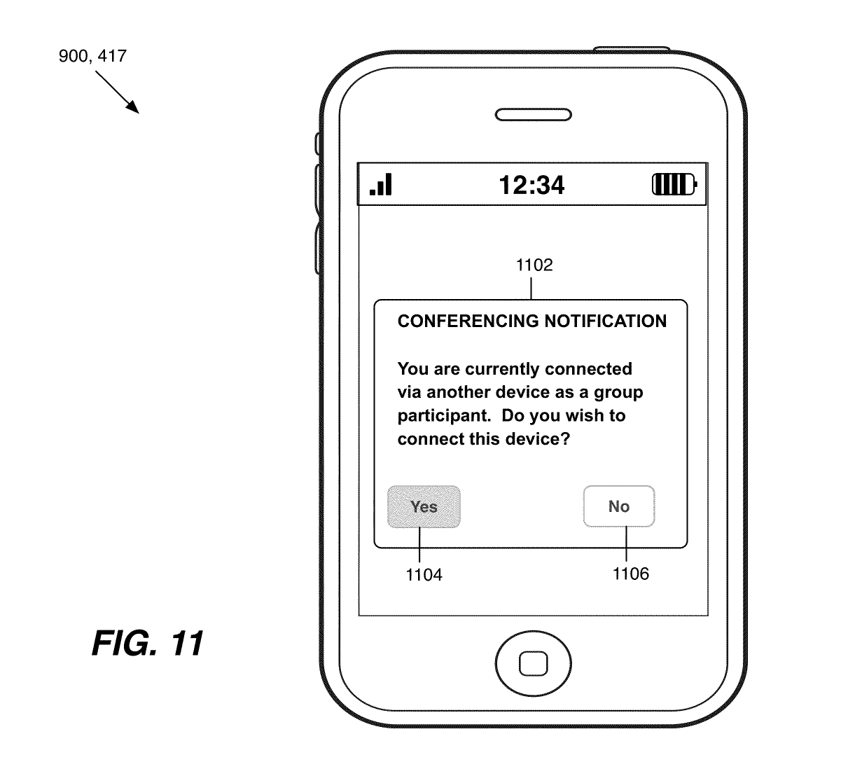

FIG. 10 illustrates an embodiment of a method for enabling a co-located participant 112 to establish the second connection 904. Blocks 1002, 1004, 1006, and 1008 may comprise the functions described above in blocks 502, 504, 506, and 508 (FIG. 5), respectively, for generally establishing the group participant 114. In one embodiment, at block 1010, the co-located participant 112e may initiate a request from the second client device 902 to connect to the online conference. In another embodiment, at block 1012, the conferencing system 102 may send a send a message to the participant 112e. As illustrated in the embodiment of FIG. 11, the second client device 902 may be running the mobile conferencing application 417, which maintains a communication channel with the conferencing system 102. When the participant 112e is added to the group participant 114 and the communication channel is active, the conferencing system 102 may automatically send an alert notification 1102 to the second client device 902. The alert notification 1102 may include a message prompting the participant 112e to establish the second connection 904 (e.g., “yes” button 1104 and “no” button 1106).

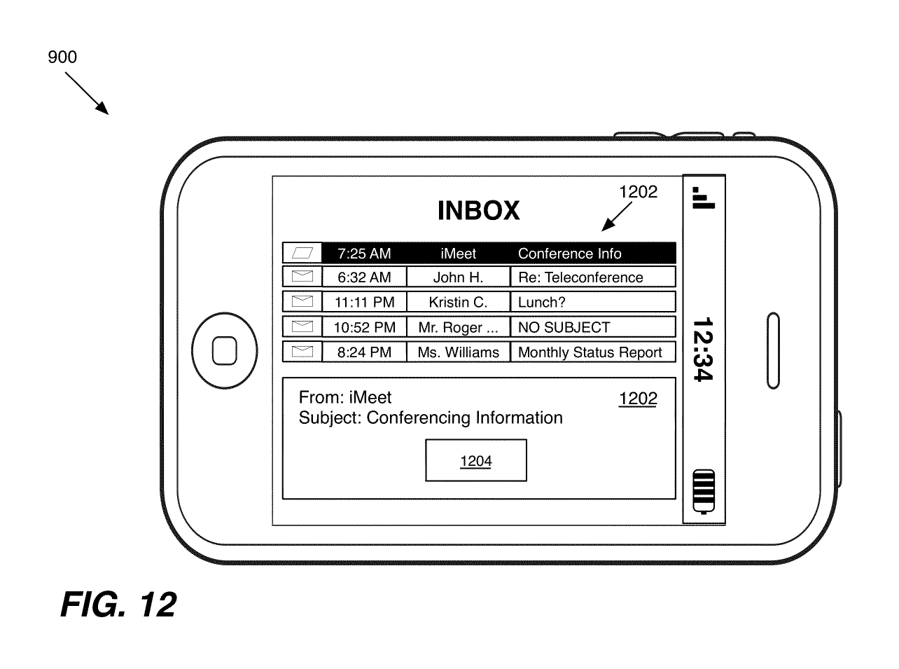

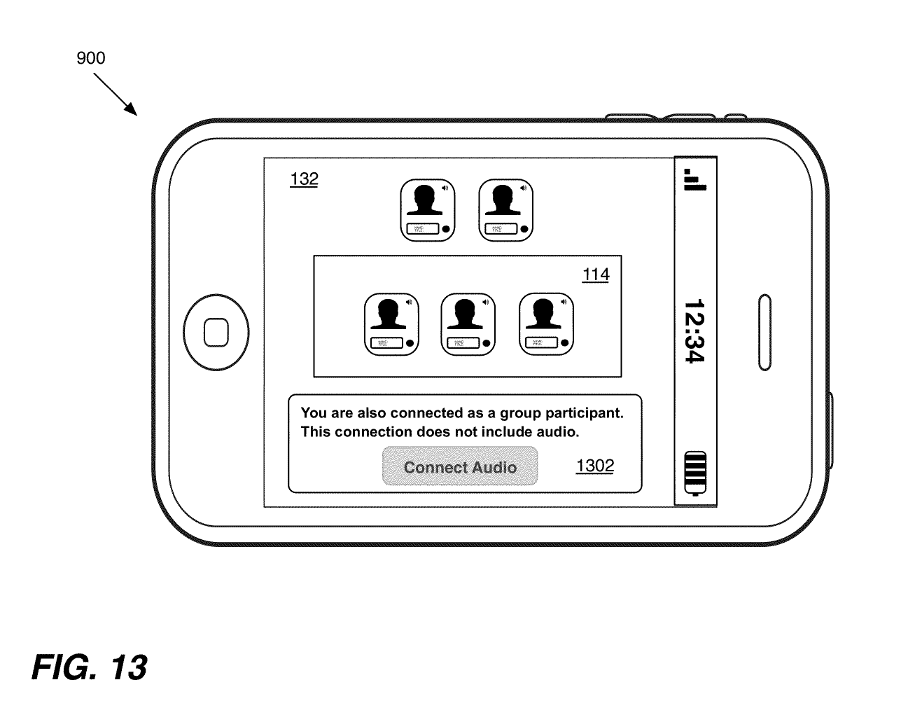

In the embodiment illustrated in FIG. 12, the conferencing system 102 may send a short message service (SMS) message, email message, or other message 1202 to the second client device 902. The message 1202 may be sent at the time the online conference is scheduled, in response to the participant 112e being added to the group participant 114, or otherwise. The message 1202 may include a link 1204 to establish the second connection 904 or otherwise enable the participant 112e to establish the second connection. Referring again to FIG. 10, at decision block 1014, the conferencing system 102 determines whether a second connection 904 is to be established. If so, the conferencing system 102 configures the second connection 904 with the online conference and may present (block 1016) the conference user interface 132 to the second client device 902 (FIG. 13).

As mentioned above, the second connection 904 may include a separate audio stream 122 or not. If the participant 112e desires to use the connection 906 for the audio conference 108, a message 1302 may be displayed indicating that the audio connection is via client device 104c. The message 1302 may also prompt the participant 112e to establish an audio connection with the second client device 900. After the second connection 904 is established, the participant 112e may interact with the participants 112 via the second client device 902 and/or the client device 104c.

It should be appreciated that one or more of the process or method descriptions associated with the flow charts or block diagrams above may represent modules, segments, logic or portions of code that include one or more executable instructions for implementing logical functions or steps in the process. It should be further appreciated that the logical functions may be implemented in software, hardware, firmware, or any combination thereof. In certain embodiments, the logical functions may be implemented in software or firmware that is stored in memory or non-volatile memory and that is executed by hardware (e.g., microcontroller) or any other processor(s) or suitable instruction execution system associated with the described computer systems. Furthermore, the logical functions may be embodied in any computer readable medium for use by or in connection with an instruction execution system, apparatus, or device, such as a computer-based system, processor-containing system, or other system associated with the described computer systems that can fetch the instructions from the instruction execution system, apparatus, or device and execute the instructions.

It should be noted that this disclosure has been presented with reference to one or more exemplary or described embodiments for the purpose of demonstrating the principles and concepts of the invention. The invention is not limited to these embodiments. As will be understood by persons skilled in the art, in view of the description provided herein, many variations may be made to the embodiments described herein and all such variations are within the scope of the invention.

What is claimed is:

1. A method for providing an online conference, the method comprising:
a conferencing system establishing an audio conference with a plurality of client devices via a communication network, each client device associated with a first participant;
the conferencing system determining at least one secondary participant co-located with one of the first participants and the corresponding client device; and
the conferencing system presenting, to each of the client devices, the audio conference and a conference user interface, the conference user interface displaying a participant object identifying each of the first and second participants.

2. The method of claim 1, wherein the conference user interface identifies the second participant and the corresponding first participant as a group participant participating at a single location.

3. The method of claim 1, wherein the conferencing system determining the second participant co-located with the corresponding first participant and client device comprises the corresponding first participant adding the second participant via the conference user interface.

4. The method of claim 1, wherein the conferencing system determining the second participant co-located with the corresponding first participant and client device comprises:
the corresponding client device capturing an image of the second participant;
the corresponding client device sending the image to the conferencing system; and
the conferencing system identifying the second participant based on the image.

5. The method of claim 4, wherein the conferencing system identifying the second participant based on the image comprises comparing the image to user image data stored in a database.

6. The method of claim 1, wherein the conferencing system determining the second participant co-located with the corresponding first participant and client device comprises processing an audio stream associated with the corresponding client device.

7. The method of claim 6, wherein the processing the audio stream associated with the corresponding client device comprises: comparing the audio stream to user voice data stored in a database.

8. The method of claim 1, wherein the conference user interface identifies the second participant and the corresponding first participant as a group participant participating in the audio conference at a single location.

9. The method of claim 1, further comprising:
the conferencing system receiving a request, from a further client device associated with the second participant, to connect to the conference user interface without establishing an audio connection; and
the conferencing system presenting the conference user interface to the further client device.

10. The method of claim 9, further comprising the second participant interacting with one or more of the first participants via the further client device.

11. A computer program embodied in a computer readable medium and executable by a processor for providing an online conference, the computer program comprising:
logic configured to establish an audio conference with a plurality of client devices via a communication network, each client device associated with a first participant;
logic configured to present, to each of the client devices, the audio conference and a conference user interface, the conference user interface displaying a participant object identifying each of the first participants;
logic configured to determine, during the audio conference, an identity of a second participant co-located with one of the first participants and the corresponding client device; and
logic configured to add a further participant object to the conference user interface to identify the second participant.

12. The computer program of claim 11, further comprising logic configured to identify the participant objects associated with the second participant and the corresponding first participant as a group participant in the conference user interface.

13. The computer program of claim 11, wherein the logic configured to determine the identity of the second participant comprises the corresponding first participant specifying the second participant via the conference user interface.

14. The computer program of claim 11, wherein the logic configured to determine the identity of the second participant comprises one of:
comparing an image of the second participant captured by the corresponding client device to user image data stored in a database; and
processing an audio stream associated with the corresponding client device and comparing the audio stream to user voice data stored in the database.

15. The computer program of claim 11, further comprising:
logic configured to provide the conference user interface to a further client device associated with the second participant without establishing an audio connection to the further client device.

16. The computer program of claim 11, further comprising:
logic configured to enable the second participant to interact with one or more of the first participants via the conference user interface presented on further client device.

17. A computer system comprising:
a conferencing system for establishing an audio conference with a plurality of client devices via a communication network, each client device associated with a first participant in the audio conference; and
a server configured to communicate with the conferencing system and the plurality of client devices via the communication network, the server configured to:
present, to each of the client devices, the audio conference and a conference user interface, the conference user interface displaying a participant object identifying each of the first participants;
determine an identity of a second participant co-located with one of the first participants and the corresponding client device; and
in response to determining the identity of the second participant, update the conference user interface with a further participant object identifying the second participant.

18. The computer system of claim 17, wherein the server is further configured to identify the participant objects associated with the second participant and the corresponding first participant as a group participant in the conference user interface.

19. The computer system of claim 17, wherein the server determines the identity of the second participant by one of:
comparing an image of the second participant captured by the corresponding client device to user image data stored in a database; and
processing an audio stream associated with the corresponding client device and comparing the audio stream to user voice data stored in the database.

20. The computer system of claim 11, wherein the server is further configured to:
receive a request, from a further client device associated with the second participant, to connect to the conference user interface; and
in response to receiving the request, present the conference user interface to the further client device without establishing an audio connection.
